(19) United States
(12) Patent Application Publication
(10) Pub. No.: US 2019/0338655 A1
(43) Pub. Date: Nov. 7, 2019

(54) METHOD FOR OPTIMIZING A NATURAL FREQUENCY OF A ROTOR BLADE, AND ROTOR BLADE

(71) Applicant: Siemens Aktiengesellschaft, Munich (DE)

(72) Inventors: Fathi Ahmad, Kaarst (DE); Radan Radulovic, Bochum (DE)

(73) Assignee: Siemens Aktiengesellschaft, Munich (DE)

(21) Appl. No.: 16/310,547

(22) PCT Filed: Jun. 12, 2017
(86) PCT No.: PCT/EP2017/064263

§ 371 Date: Dec. 17, 2018

(30) Foreign Application Priority Data
Jun. 29, 2016 (EP) 16176789.2

(51) Int. Cl. F01D 5/30; F01D 5/26; G01H 13/00

(52) U.S. Cl. CPC F01D 5/3015; F01D 5/26; G01H 13/00; F05D 2260/96; F05D 2260/12; F05D 2260/83; F05D 2230/10

(57) ABSTRACT

A method for optimizing a design of a rotor blade which has a blade root and a blade airfoil, of a turbomachine in which an actual natural frequency of the rotor blade is detected and compared with a reference value or reference range and, if a deviation or match between the actual natural frequency and the reference value or reference range, which will impair the proper operation of the rotor blade, is identified, a structural change to the rotor blade is undertaken in order to change the natural frequency thereof, wherein as the structural change at least one cutout is formed at a predetermined position on at least one side face of the rotor blade root. A rotor blade for a turbomachine, which blade has a blade root and a blade airfoil, wherein at least one cutout is formed on at least one side face of the rotor blade root.

### CROSS REFERENCE TO RELATED APPLICATIONS

This application is the US National Stage of International Application No. PCT/EP2017/064263 filed Jun. 12, 2017, and claims the benefit thereof. The International Application claims the benefit of European Application No. EP16176789 filed Jun. 29, 2016. All of the applications are incorporated by reference herein in their entirety.

### FIELD OF INVENTION

The present invention relates to a method for optimizing a design of a rotor blade, which has a blade root and a blade airfoil, in which method an actual natural frequency of the rotor blade is detected, the detected actual natural frequency is compared with a reference value of reference range and, if a deviation or coincidence between the actual natural frequency and the reference value or reference range, which impairs the designed use of the rotor blade is detected, a structural modification is undertaken on the rotor blade for changing its natural frequency. The invention furthermore relates to a rotor blade which has a blade root and a blade airfoil.

### BACKGROUND OF INVENTION

Turbomachines, such as gas turbines, have at least one rotor blade ring, with a plurality of rotor blades, which is arranged on a rotor and rotates together with this. In the case of each of these rotor blades it is a vibratory system which is excited into vibrations during operation of the turbomachine, wherein each rotor blade basically vibrates at its natural frequencies If in dependence of the rotational speed of the rotor of the turbomachine integral multiples of the rotational frequency coincide with a natural frequency of a rotor blade, then resonance vibrations occur, having a particularly high amplitude in the event of poor damping. If a rotor blade vibrates in resonance, then the mechanical stresses which are associated therewith lead to damage of the components of the turbomachine and to a reduced service life of the subject components. Therefore, it is essential to avoid such resonances, especially resonances with so-called burner or vane excitation. A natural frequency analysis of a rotor blade is normally conducted at the end of a production process since frequency changes result on account of manufacturing tolerances and manufacturing inaccuracies, for example deviations in the wall thickness of the rotor blades. Forecasting of the natural frequency of a rotor blade at an earlier point in time is correspondingly hardly possible.

If in the course of a natural frequency analysis a detected natural frequency of a rotor blade lies within a critical resonance range, it is known to change its natural frequency. In this connection, DE 10 2009 053 247 A1 proposes to apply a material by means of an additive manufacturing process to a surface region of the rotor blade, as a result of which the mass distribution of the rotor blade and therefore its vibration frequency is changed. According to DE 10 2009 053 247 A1, the tip of the blade airfoil is especially provided with an additional coating. As a structural modification of the rotor blade it is therefore known to increase its wall thickness by applying a coating. With this measure, however, only minor frequency changes in the region of a few Hz can be achieved, which is why a shift of the natural frequency out of the resonance range is not always possible. Increasing the coating thickness of a rotor blade does not therefore constitute a robust and reliable natural frequency correction measure, which in case of doubt leads to newly produced rotor blades being declared as scrap. Moreover, increasing the coating thickness creates other problems since the thicknesses of functional coatings are purposefully selected in the original design of the rotor blade. Therefore, a change of a coating thickness can for example have a negative effect upon the thermal loadability of the rotor blade.

In addition, it is known from US 2013/209253 A1 and from JP S63-97803 A to modify the size of the pressure surface of the bearing flanks of rotor blades in order to adjust the natural frequencies.

### SUMMARY OF INVENTION

Against this background, the present invention is based on an object of providing a method for optimizing a design of a rotor blade for a turbomachine, which method makes it possible to change a natural frequency of the rotor blade in a simple and reliable manner so that this clearly lies outside a critical frequency range. Also to be specified is a rotor blade with a design which is optimized in this sense.

For achieving this object, the present invention creates a method of the type referred to in the introduction, which is characterized in that at least one cutout is formed at a predetermined position on at least one side face of the rotor blade root as the structural modification.

In view of the fact that the fastening of the rotor blade root in a blade root socket provided on the rotor substantially influences the vibration frequency of the rotor blade during operation of a turbomachine, the contact surface between the rotor blade root and the blade root socket is reduced in a targeted manner as a result of the forming according to the invention of at least one cutout, in order to influence the vibration frequency of the rotor blade in this way. This provision therefore especially constitutes a good adjusting screw for a reliable changing of a natural frequency of the rotor blade since the natural frequency of the rotor blade can be varied to a comparatively great extent. Furthermore, the remaining design of the rotor blade is not impaired, which is why the method according to the invention does not create any consequential problems. It can also be implemented in a simple and inexpensive manner.

In addition, for detecting the actual natural frequency the rotor blade is inserted by its rotor blade root in a blade root socket of an excitation device of a vibration test bench so that surfaces of the blade root and of the blade root socket are in contact. Consequently, a vibration is excited in the rotor blade and the excited vibration of the rotor blade is measured. The blade root socket of the vibration test bench especially has the same geometry, within defined manufacturing tolerances, as an actual blade root socket, formed in the rotor, for the rotor blade. Therefore, it is possible at little outlay to carry out frequency measurements on the rotor blade. The detected actual frequency makes it possible to assess whether structural modifications in the form of forming at least one cutout on the rotor blade root has to be undertaken.

If the change of the natural frequency of a rotor blade is necessary, then the predetermined position of the at least one cutout is determined by a plate, having at least one hole, especially at least one circular hole, advantageously a hole pattern, being arranged between a side face of the blade root and the blade root socket of the excitation device of the vibration test bench. Consequently, the natural frequency of the rotor blade which is changed on account of the at least one hole is detected again and compared with the reference value or reference range. If the result is satisfactory, then the predetermined position will be identified. Otherwise, the process is repeated with varying hole dimensions and/or hole positions until a satisfactory result is established.

The plate is advantageously a thin plate, especially in the form of an elongate rail, especially consisting of metal, advantageously with a thickness of between 0.1 and 2 mm, which is releasably fastened, particularly by means of adhesive fixing, on the side face of the blade root. A thin plate offers the advantage that it can be arranged without any problem between the side face of the blade root and the blade root socket. Since the thin plate is fastened on an elongate side face of the rotor blade root, an elongate shape is particularly advantageous. Fastening of the thin plate on a side face by means of an adhesive connection which can be released again offers the advantage that the thin plate can be removed again after its use. The use of a metal plate is particularly advantageous since this has similar mechanical and thermal properties as the rotor blade. After attaching the thin plate to the side face of the rotor blade, it can also be advantageous if the thin plate is of a flexible and bendable design.

The thin plate is advantageously arranged at different positions between the side face of the rotor blade root and the blade root socket, or exchanged with other thin plates with different hole arrangements, until no deviation or coincidence between the last detected natural frequency and the reference value or reference range, which impairs the designed use of the rotor blade, is detected any longer. The at least one cutout is then formed at the position of the at least one hole. For this, the plate can serve as a template for marking the predetermined position.

The at least one cutout is advantageously formed by removing a small amount of blade material, especially by eroding, drilling, milling, grinding, “smooth blending” and/or by other methods for material removal, in such a way that during a designed use of the rotor blade a contact between the blade root and a blade root socket is directly prevented. The drilling of holes into the side face of the rotor blade root is in this case particularly advantageous since it is quick, simple and inexpensive. In the case of the “smooth blending” technique, transitions are not cornered, but “smooth”, that is to say rounded for example.

After the forming of the at least one cutout has been carried out, the perforated plate which has been used, or the perforated plates which have been used, can be reused for another rotor blade. This saves costs and resources.

Alternatively, the plate, which especially has an elongate shape, is inserted into a recess, especially a groove, which is provided on the side face of the blade root, in such a way that the plate terminates with the side face of the blade root in a flush manner. A flush termination is advantageous since as a result of this the blade root can be inserted into a corresponding blade root socket without any problem. Regardless of this, it should be obvious that it is basically also possible that the plate in comparison with the previously described thin plate slightly projects from the side face of the blade root. Length and width of the recess advantageously coincide with those of the plate so that the plate completely fills out the recess.

The recess can already be formed during production of the rotor blade, for example during the casting process, wherein after the production of the rotor blade its actual natural frequency is initially detected with a hole-free reference plate which is inserted into the recess, or the recess can only be introduced into the side face of the blade root when a deviation or coincidence between the actual natural frequency and the reference value or reference range is detected. The forming of the recess during production of the rotor blade offers the advantage that the rotor blade is already provided with a recess for all cases, even if a change of a natural frequency is initially not required, but possibly becomes necessary during operation. On the other hand, it is also definitely advantageous if the recess is only introduced when required since the stability of the rotor blade is not compromised by notch effect or the like.

Plates with different hole arrangements are advantageously inserted into the recess of the blade root until no deviation or coincidence between the last detected natural frequency and the reference value or reference range, which impairs the designed use of the rotor blade, is detected any longer. The plate then remains unaltered and permanently as a component part of the rotor blade in its recess so that the at least one hole of the plate forms the at least one cutout.

For achieving the object referred to in the introduction, the present invention also creates a rotor blade of the type referred to in the introduction, which rotor blade is characterized in that at least one cutout is formed on at least one of those side faces of the rotor blade root against which butts the rotor blade by centrifugal force on the bearing flanks of the blade root socket of the rotor during the designed use in a turbomachine during operation.

In other words, the cutout is located on that side face of the rotor blade root which is pressed flat against the rotor by centrifugal force. The forming of the at least one cutout can especially be carried out by means of the previously described method according to the invention. The advantages of such a cutout have already been explicitly described previously, which is why they have not been dealt with again at this point.

Furthermore, a recess, especially an elongate groove, is formed on the surface of the blade root, in which recess a corresponding plate, especially an elongated rail, advantageously consisting of metal, is fastened in a predetermined position, wherein the plate especially terminates with the surface of the blade root in a flush manner and the at least one cutout, especially in the form of a blind hole or a through-hole, is formed in the plate. It is particularly advantageous if the length of the plate corresponds to the length of the recess so that the plate completely fills out the recess. The fastening of the plate in the recess is advantageously carried out by means of adhesive fixing, soldering or welding. It should be obvious, however, that the fastening can basically also be carried out by means of other methods, such as clamping, latching engagement and/or riveting. Although a flush termination is advantageous, since as a result of this the blade root can be inserted into a blade root socket without any problem, it is also possible that the plate slightly projects beyond the surface of the rotor blade root. Both the recess and the plate can in principle have any chosen shape, such as a rectangular, quadratic, oval or polygonal cross-sectional shape. The same applies to the cutout, wherein in this case a circular hole is advantageous since it can be produced in a simple, quick and inexpensive manner.

The at least one cutout is advantageously in the form of a drilled hole with a circular cross section. Such a cutout is particularly advantageous since it can be formed quickly and easily by drilling. It should be obvious, however, that the cutout can in principle also have any chosen other cross-sectional shape, such as quadratic, rectangular, oval or have a generally polygonal shape. It can also be advantageous if the at least one cutout has rounded transitions.

The recess advantageously extends over approximately 90% of a side face of the blade root or over the complete length of the side face and into the two end faces of the blade root. In the event that the recess extends over approximately 90% of a side face, it is particularly advantageous if the recess does not extend into either of the end faces. As a result of this, no additional fastening against a translation of the plate into the recess is necessary.

With regard to further possible features, technical effects and advantages of the rotor blade according to the invention, reference is made to the previous description of the method according to the invention.

### BRIEF DESCRIPTION OF THE DRAWINGS

Further features and advantages of the present invention become clear based on the following description of two exemplary embodiments of a method for optimizing a design of a rotor blade having a rotor blade according to the present invention with reference to the attached drawing. In the drawing

FIG. 1 shows a schematic front view of a rotor blade during the conducting of a first step of a method according to an embodiment of the present invention;

FIG. 2 shows a perspective schematic view of a blade root of the rotor blade shown in FIG. 1 during the conducting of a second method step;

FIG. 3 shows a perspective schematic view of a blade root of the rotor blade shown in FIG. 1 during the conducting of a third method step;

FIG. 4 shows a perspective schematic view of a blade root of the rotor blade shown in FIG. 1 during the conducting of a fourth method step;

FIG. 5 shows a perspective schematic view of a blade root of the rotor blade shown in FIG. 1 after the conducting of a fifth method step;

FIG. 6 shows a perspective schematic view of a rotor blade during the conducting of a second step of a method according to a second embodiment of the present invention;

FIG. 7 shows a perspective schematic view of a blade root of the rotor blade shown in FIG. 6 during the conducting of a third method step; and

FIG. 8 shows a perspective schematic view of a blade root of the rotor blade shown in FIG. 6 after the conducting of a fourth method step.

### DETAILED DESCRIPTION OF INVENTION

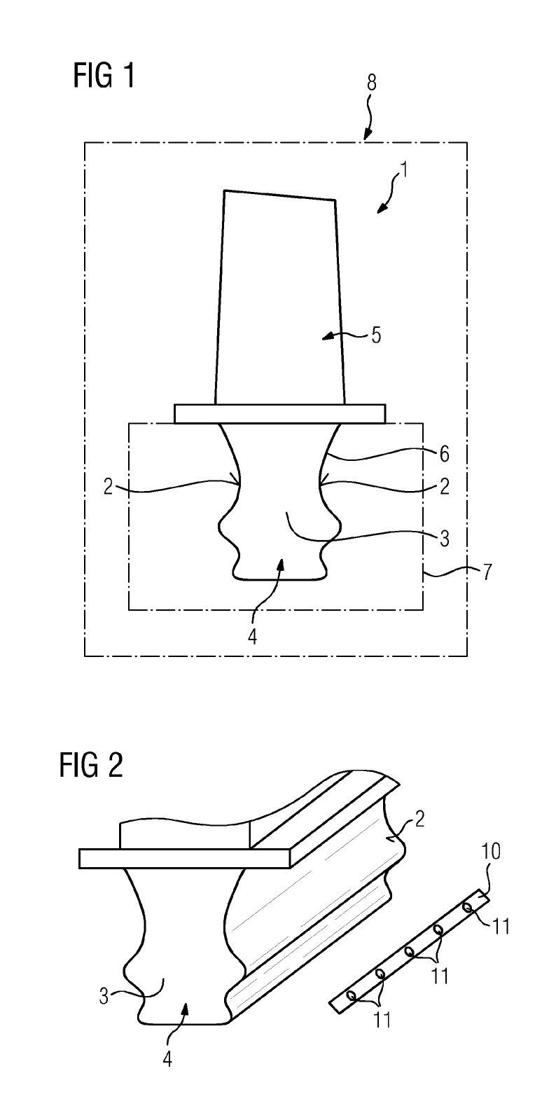

FIGS. 1 to 5 show a rotor blade 1 with a blade root 4, which defines side faces 2 and end faces 3, and a blade airfoil 5 during five consecutive steps of a method according to a first embodiment of the present invention, which method is implemented for optimizing the design of the rotor blade 1.

The blade root 4 is usually of firtree or dovetail design so that its end face 3 is flat. The rotor blade 1 shown in the figures is provided for example for being inserted in a rotor with axial grooves. If in the following text mention is made of the side face 2 of the blade root, then it is understood as those regions which interconnect the two oppositely disposed, flat end faces 3 and which butt against walls of a blade retention groove of the rotor by centrifugal force during the designed use of the rotor blade in a turbine or in a compressor during operation.

According to FIG. 1, an actual natural frequency of the rotor blade 1 is initially detected in a first step. To this end, the rotor blade is inserted by its blade root 4 into a blade root socket 6 of an excitation device 7 of a vibration test bench 8 in such a way that the side faces 2 of the blade root 4 and the surfaces of the blade root socket 6 are in contact with each other. After this, the rotor blade 1 is excited into vibrations, whereupon an actual natural frequency of the rotor blade 1 is detected. During this, the blade root socket 6 of the excitation device 7 simulates the blade root socket of a rotor of that turbomachine in which the rotor blade 1 is to be subsequently used. The detected actual natural frequency is then compared with an acceptable, previously determined reference range. If a deviation between the actual natural frequency and the acceptable reference range, which impairs the designed use of the rotor blade 1, is detected, then a structural modification is undertaken on the rotor blade 1 according to the invention in such a way that a cutout 9 is formed in one of the side faces 2 of the blade root 4 at at least one predetermined position in order to change the actual natural frequency to the desired extent.

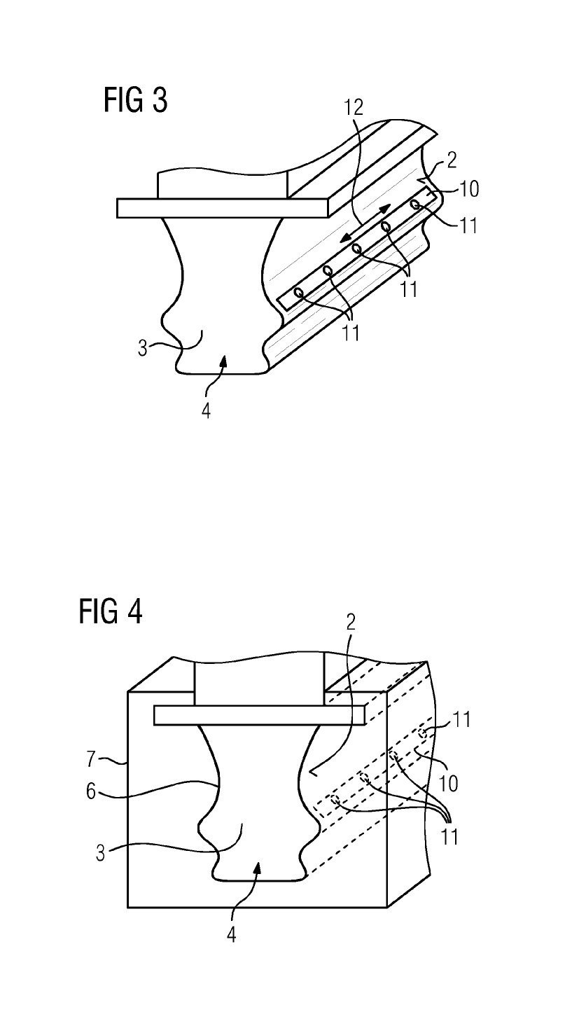

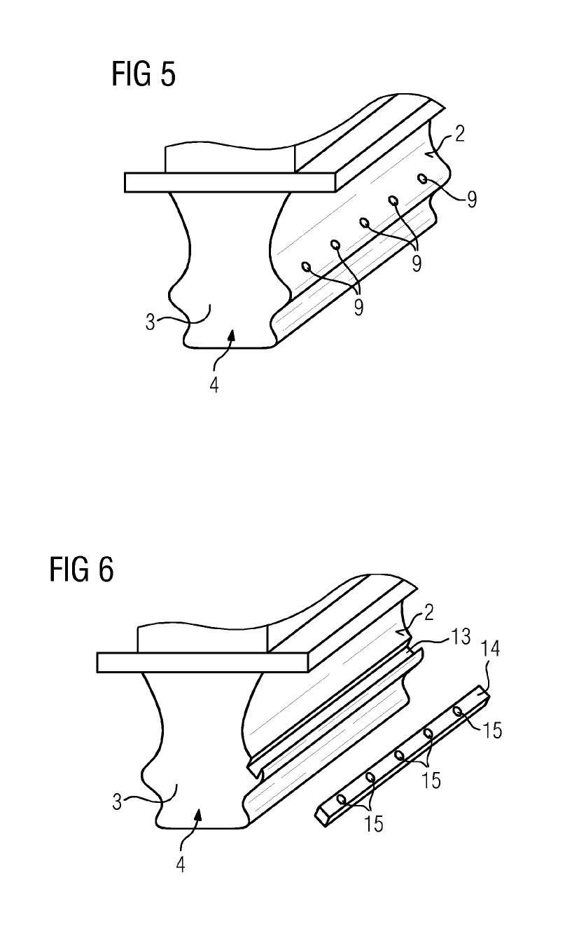

According to a first embodiment of a method according to the invention, in this connection according to FIGS. 2 and 3 the predetermined positions at which cutouts 9 are to be formed in order to effect the desired change of the natural frequency of the rotor blade 1 are initially established. In this connection, a thin, approximately 0.5 mm thick plate 10 of elongate design and produced from metal, which is provided with a plurality of holes 11, is releasably fastened, for example by means of adhesive fixing, on a side face 2 of the blade root 4, after which the blade root 4 according to FIG. 4 is inserted into the blade root socket 6 of the excitation device 7 again and the new natural frequency of the rotor blade 1 with the plate 10 mounted thereupon is determined. The new natural frequency does not coincide with the original natural frequency since the holes 11 of the plate 10 in the contact region between the blade root 4 and the blade root socket 6 form imperfections or non-contact surfaces which influence the natural frequency. If the new natural frequency continues to lie outside the acceptable reference range, then the method steps shown in FIGS. 2 to 4 are repeated, shifting the plate 10 in the direction of the double arrow 12 until a desired natural frequency is established. If this should not be the case, then another plate 10 with a different hole pattern can be used. As soon as the natural frequency lies within the acceptable reference range, the predetermined positions at which the cutouts 9 are located are marked, using the plate 10 as a template, after which the plate 10 is removed from the blade root 4. After that, in a last step, advantageously flat cutouts 9 are formed on the side face 2 of the blade root 4 at the predetermined positions with minor material removal, for example by means of drilling, milling, “smooth blending” or the like, so that the arrangement shown in FIG. 5 is produced. During the designed use of the rotor blade 1 in a turbomachine these cutouts 9 form non-contact points between the side faces 2 of the blade root 4 and a blade root socket of the turbomachine, which lead to a corresponding natural frequency of the rotor blade 1 which lies outside the resonance range.

It should be obvious that the shape and dimensions of the plate 10, as well as the shape, the dimensions and the number of cutouts 9, can vary. Also, in the steps shown in FIGS. 2 to 4 a plurality of plates 10 can be arranged on the blade root 4, for example on both side faces 2 of the blade root 4.

FIGS. 6 to 8 show method steps of an alternative method according to an embodiment of the present invention. In the case of this method, in a first method step similar to FIG. 1 the actual natural frequency of the rotor blade 1 is determined. If this does not lie within the acceptable reference range, then in a second step, similar to the previously described method, predetermined positions at which cutouts 9 are to be provided on a side face 2 of the blade root 4 of the rotor blade 1 in order to shift the natural frequency of the rotor blade 1 into the acceptable reference range, are established.

To this end, as is shown in FIG. 5, a recess 13, in the form of a groove in the present case, is formed in a side face 2 of the blade root 4, for example by means of milling or the like, which recess extends in the present case in a straight line from one end face 3 to the opposite end face 3 of the blade root 4. Alternatively, the recess 13 can also extend over approximately 90% of the side face 2 and especially into neither of the two end faces 3. A plate 14, which is provided with a plurality of holes 15, is then inserted into the recess 13 in such a way that the holes 15 point outward. The dimensions of the plate 14 correspond in the main to those of the recess 13, wherein the upper side of the plate 14, in the state inserted into the recess 13, advantageously terminates flush with the blade root 4 or slightly projects from the surface of the blade root.

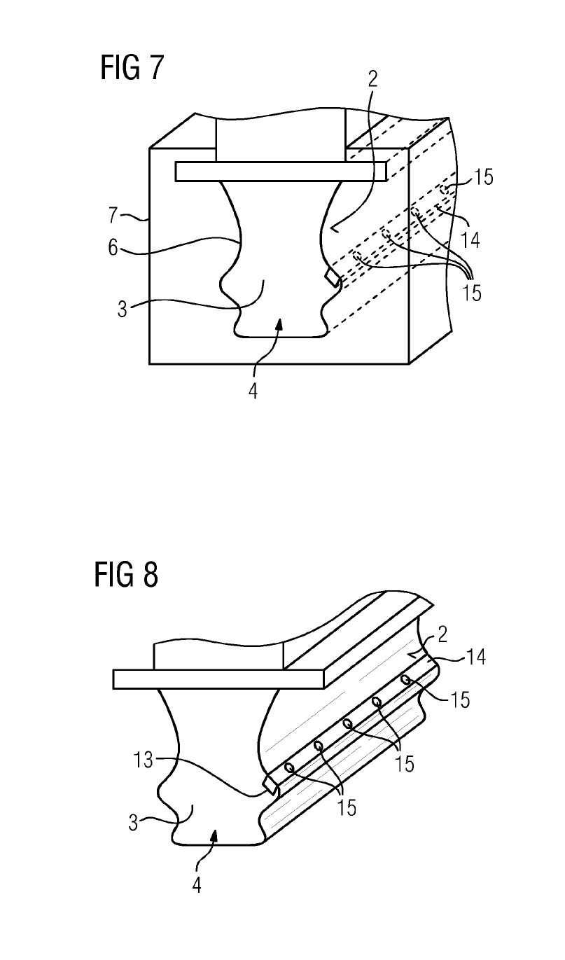

In a further step, according to FIG. 6, similar to FIG. 4, the new natural frequency of the rotor blade 1 with the plate 14 mounted thereupon is determined. If this does not lie within the acceptable reference range, then the steps shown in FIGS. 6 and 7 are repeated using plates 14 which have different hole patterns until a desired natural frequency is established. If this is the case, then that plate 14 by means of which the desired natural frequency was achieved is fastened inside the recess 13 on the blade root 4, for example by means of soldering or the like, so that the arrangement shown in FIG. 8 is produced.

The holes 15 now define cutouts similar to the cutouts 9 shown in FIG. 5 and, during the designed use of the rotor blade 1 in a turbomachine, form non-contact points between the side faces 2 of the blade root 4 and a blade root socket of the turbomachine, which lead to a corresponding natural frequency of the rotor blade 1 which lies outside the resonance range.

It should be obvious that the shape, the dimensions as well as the number of recesses 13 and plates 14 as well as the shape, the dimensions, the positions and the number of holes 15 provided in the plate 14 can vary. Furthermore, the recess 13 can also already be provided during production of the rotor blade 1. In this case, the first detecting of the actual natural frequency is conducted using a reference plate, without holes 15, inserted into the recess 13.

Although the invention has been fully illustrated and described in detail by means of the advantageous exemplary embodiment, the invention is not limited by the disclosed examples and other variations can be derived therefrom by the person skilled in the art without departing from the extent of protection of the invention.

1. A method for optimizing a design of a rotor blade, which has a blade root and an airfoil, of a turbomachine, the method comprising:
detecting an actual natural frequency of the rotor blade,
comparing the detected actual natural frequency with a reference value or reference range and, for a detection of a deviation or coincidence between the actual natural frequency and the reference value or reference range, which impairs the designed used of the rotor blade, undertaking a structural modification on the rotor blade for changing its natural frequency,
forming at least one cutout at a predetermined position on at least one side face of the blade root as the structural modification,
wherein for detecting the actual natural frequency, the rotor blade is inserted by its blade root into a blade root socket of an excitation device of vibration test bench so that surfaces of the blade root and of the blade root socket are in contact, a vibration is excited in the rotor blade and the excited vibration of the rotor blade is measured,
wherein the predetermined position of the at least one cutout is determined by a plate with at least one hole being arranged between a side face of the blade root and the blade root socket of the excitation device of the vibration test bench, and the natural frequency of the rotor blade is detected again and compared with the reference value or reference range.

2. The method as claimed in claim 1,
wherein the plate is a thin plate which is releasably fastened on the side face of the blade root.

3. The method as claimed in claim 2,
wherein the thin plate is arranged at different positions between the side face of the blade root and the blade root socket, or exchanged with other thin plates with different hole arrangements, until no deviation or coincidence between the last detected natural frequency and the reference value or reference range, which impairs a designed use of the rotor blade, is detected any longer, and then the at least one cutout is formed at the position of the at least one hole.

4. The method as claimed in claim 3,
wherein the at least one cutout is formed by removing a small amount of blade material in such a way that a contact between the blade root and a blade root socket is directly prevented during a designed use of the rotor blade.

5. The method as claimed in claim 1,
wherein the plate is inserted into a recess which is provided on the side face of the blade root, in such a way that the plate terminates with the side face of the blade root in a flush manner.

6. The method as claimed in claim 5,
wherein the recess is formed during production of the rotor blade, wherein after production of the rotor blade, its actual natural frequency is initially detected using a hole-free reference plate which is inserted into the recess, or the recess is introduced into the side face of the blade root only when the deviation or coincidence between the actual natural frequency and the reference value or reference range is detected.

7. The method as claimed in claim 5,
wherein plates with different hole arrangements are inserted into the recess of the blade root until no deviation or coincidence between the last detected natural frequency and the reference value or reference range is detected any longer, and the plate then remains in an unmodified state and permanently as a component part of the rotor blade in its recess so that the at least one hole of the plate forms the at least one cutout.

8. A rotor blade for a turbomachine, comprising:
a blade root having side faces,
a blade airfoil,
at least one cutout which is formed on at least one of the side faces of the blade root against which the rotor blade butts during a designed use in the turbomachine during operation by centrifugal force on bearing flanks of a blade root socket of the rotor, and
a recess which is formed on a surface of the blade root, in which recess a corresponding plate is fastened, wherein the plate terminates with the surface of the blade root in a basically flush manner and the at least one cutout is formed in the plate.

9. The rotor blade as claimed in claim 8,
wherein the at least one cutout comprises a drilled hole with a circular cross section.

10. The rotor blade as claimed in claim 8,
wherein the recess extends over approximately 90% of a side face of the blade root or over an entire length of the side face and into two end faces of the blade root.

11. The method as claimed in claim 1,
wherein the predetermined position of the at least one cutout is determined by a plate with at least one circular hole.

12. The method as claimed in claim 1,
wherein the predetermined position of the at least one cutout is determined by a plate with a hole pattern.

13. The method as claimed in claim 2,
wherein the thin plate consists of metal.

14. The method as claimed in claim 2,
wherein the thin plate has a thickness of between 0.1 and 2 mm.

15. The method as claimed in claim 2,
wherein the thin plate is releasably fastened by adhesive fixing.

16. The method as claimed in claim 4,
wherein the at least one cutout is formed by removing a small amount of blade material by eroding, drilling, milling, grinding, and/or smooth blending.

17. The rotor blade as claimed in claim 8,
wherein the recess is an elongate groove.

18. The rotor blade as claimed in claim 8,
wherein the at least one cutout comprises a blind hole or a through-hole formed in the plate.
